(19) United States
(12) Patent Application Publication
(10) Pub. No.: US 2006/0251253 A1
(43) Pub. Date: Nov. 9, 2006

(54) Cryptographically signed network identifier

(75) Inventors: Elizabeth M. Kappler, Hillsboro, OR (US); Scott P. Dubal, Hillsboro, OR (US)

Correspondence Address: Caven & Aghevli LLC;PortfolioIP, P.O. Box 52050, Minneapolis, MN, 55402, US

(73) Assignee: Intel Corporation

(21) Appl. No.: 11/095,003

(22) Filed: Mar. 31, 2005

(51) Int. Cl. H04K 1/00

(52) U.S. Cl. 380/255

(57) ABSTRACT

In one embodiment, an apparatus includes a network controller to communicate with a network. The apparatus may also include a storage device that is coupled to the network controller to store a cryptographically signed unique network identifier.

### TECHNICAL FIELD

The present disclosure generally relates to the field of computer networking. More particularly, an embodiment relates to a cryptographically signed network identifier.

### BACKGROUND

Most computers today include a network adapter to provide access to a network resource. These adapters, however, may be counterfeited and sold as the genuine item. Generally, counterfeit network adapters closely resemble the genuine item. Users who purchase or have to deal with issues posed by counterfeit network adapters lose time and money in the process. Additionally, manufacturers of genuine network adapters are faced with financial losses through lost sales and time, as well as potential damage to their reputation for providing inferior products.

To make matters worse, genuine network adapter manufactures often do not realize whether a network adapter is counterfeit until a user returns the offending adapter to the manufacturer for inspection, repair, or because of other problems. At that point, an expert can inspect the network adapter to determine whether it is counterfeit.

Accordingly, counterfeit network adapters result in losses to both the genuine-product manufacturers and the users of such products.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates various components of an embodiment of a networking environment.

FIG. 2 illustrates a block diagram of a computing device in accordance with an embodiment.

FIG. 3 illustrates further details of the network interface device 230 of FIG. 2, in accordance with an embodiment.

FIG. 4 illustrates a flow diagram of a method for providing a cryptographically signed network identifier in accordance with an embodiment.

FIG. 5 illustrates further details regarding the stage 406 of FIG. 4, in accordance with an embodiment.

FIG. 6 illustrates a flow diagram of a method for determining whether a private key is comprised, in accordance with an embodiment.

### DETAILED DESCRIPTION

In the following description, numerous specific details are set forth in order to provide a thorough understanding of various embodiments. However, it will be understood by those skilled in the art that the various embodiments may be practiced without the specific details. In other instances, well-known methods, procedures, components, and circuits have not been described in detail so as not to obscure the particular embodiments.

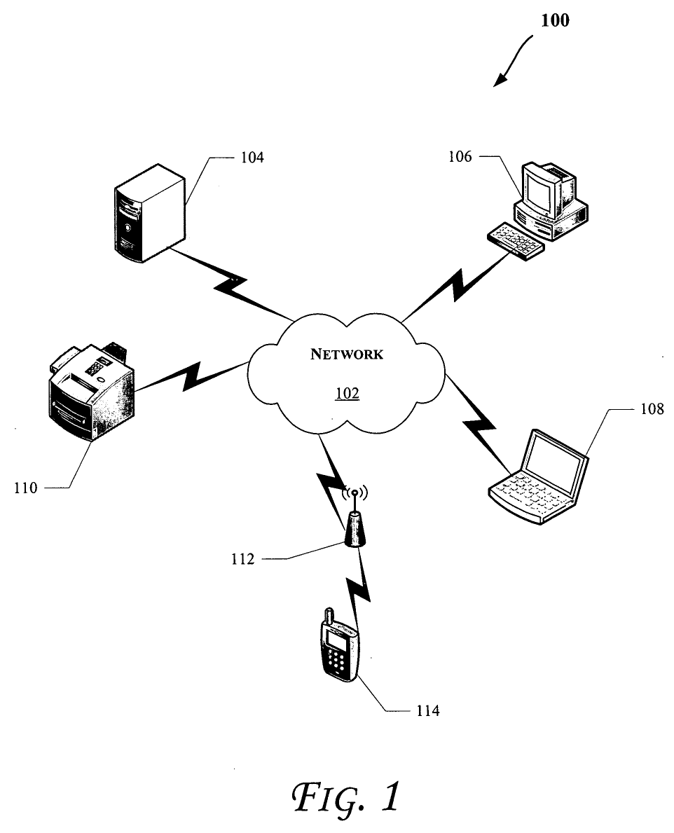

FIG. 1 illustrates various components of an embodiment of a networking environment 100, which may be utilized to implement various embodiments discussed herein. The environment 100 includes a network 102 to enable communication between various devices such as a server computer 104, a desktop computer 106 (e.g., a workstation or a desktop computer), a laptop (or notebook) computer 108, a reproduction device 110 (e.g., a network printer, copier, facsimile, scanner, all-in-one device, and the like), a wireless access point 112, a personal digital assistant or smart phone 114, a rack-mounted computing device (not shown), and the like. The network 102 may be any suitable type of a computer network including an intranet, the Internet, and/or combinations thereof.

Devices (e.g., 104-114) may be coupled to the network 102 through wired and/or wireless connections. Hence, the network 102 may be a wired and/or wireless network. For example, as illustrated in FIG. 1, the wireless access point 112 may be coupled to the network 102 to enable other wireless-capable devices (such as 114) to communicate with the network 102. Alternatively, the network 102 may support wireless communication without the access point 114, e.g., through a wireless router or hub.

The network 102 may utilize any suitable communication protocol such as Ethernet, Fast Ethernet, Gigabit Ethernet, wide-area network (WAN), fiber distributed data interface (FDDI), Token Ring, leased line (such as T1, T3, optical carrier 3 (OC3), and the like), analog modem, digital subscriber line (DSL and its varieties such as high bit-rate DSL (HDSL), integrated services digital network DSL (IDSL), and the like), asynchronous transfer mode (ATM), cable modem, and/or FireWire.

Wireless communication through the network 102 may be in accordance with one or more of the following: wireless local area network (WLAN), wireless wide area network (WWAN), code division multiple access (CDMA) cellular radiotelephone communication systems, global system for mobile communications (GSM) cellular radiotelephone systems, North American Digital Cellular (NADC) cellular radiotelephone systems, time division multiple access (TDMA) systems, extended TDMA (E-TDMA) cellular radiotelephone systems, third generation partnership project (3G) systems such as wide-band CDMA (WCDMA), and the like. Moreover, network communication may be established by internal network interface devices (e.g., present within the same physical enclosure as a computing device) or external network interface devices (e.g., having a separated physical enclosure and/or power supply than the computing device it is coupled to) such as a network interface card (NIC).

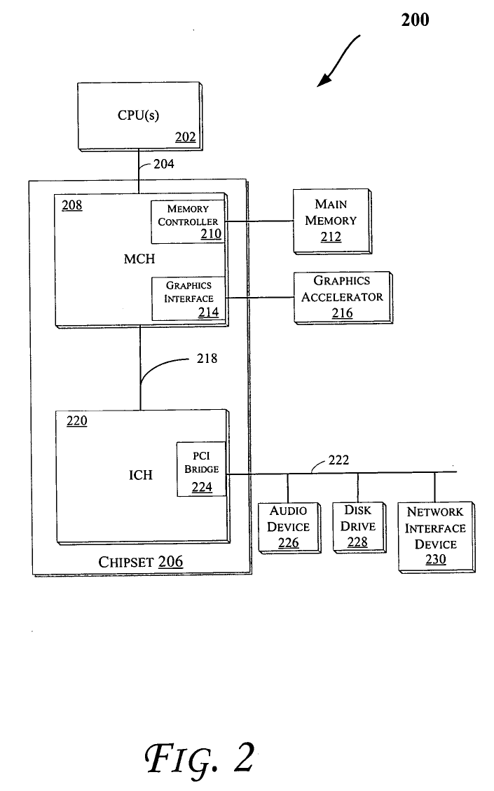

FIG. 2 illustrates a block diagram of a computing device 200 in accordance with an embodiment. The computing device 200 may be utilized to implement one or more of the devices (104-114) discussed with reference to FIG. 1. The computing device 200 includes one or more central processing unit(s) (CPUs) 202 coupled to a bus 204. In one embodiment, the CPU 202 is one or more processors in the Pentium® family of processors including the Pentium® II processor family, Pentium® III processors, Pentium® IV processors available from Intel® Corporation of Santa Clara, Calif. Alternatively, other CPUs may be used, such as Intel's Itanium®, XEON™, XScale®, and Celeron® processors. Also, one or more processors from other manufactures may be utilized. Moreover, the processors may have a single or multi core design.

A chipset 206 is also coupled to the bus 204. The chipset 206 includes a memory control hub (MCH) 208. The MCH 208 may include a memory controller 210 that is coupled to a main system memory 212. The main system memory 212 stores data and sequences of instructions that are executed by the CPU 202, or any other device included in the computing device 200. In one embodiment, the main system memory 212 includes random access memory (RAM) such as dynamic RAM (DRAM), synchronous DRAM (SDRAM), and the like. Additional devices may also be coupled to the bus 204, such as multiple CPUs and/or multiple system memories.

The MCH 208 may also include a graphics interface 214 coupled to a graphics accelerator 216. In one embodiment, the graphics interface 214 is coupled to the graphics accelerator 216 via an accelerated graphics port (AGP). In an embodiment, a display (such as a flat panel display) may be coupled to the graphics interface 214 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 218 couples the MCH 208 to an input/output control hub (ICH) 220. The ICH 220 provides an interface to input/output (I/O) devices coupled to the computing device 200. The ICH 220 may be coupled to a peripheral component interconnect (PCI) bus 222. Hence, the ICH 220 includes a PCI bridge 224 that provides an interface to the PCI bus 222. The PCI bridge 224 provides a data path between the CPU 202 and peripheral devices. Additionally, other types of topologies may be utilized such as the PCI Express™ architecture, available through Intel® Corporation of Santa Clara, Calif.

The PCI bus 222 may be coupled to an audio device 226, one or more disk drive(s) 228, and a network interface device 230. Other devices may be coupled to the PCI bus 222. Also, various components (such as the network interface device 230) may be coupled to the MCH 208 in some embodiments (e.g., the PCI Express™ architecture). As discussed with reference to FIG. 1, network communication may be established via internal and/or external network interface device(s) (230), such as an NIC. In addition, the CPU 202 and the MCH 208 may be combined to form a single chip. Furthermore, the graphics accelerator 216 may be included within the MCH 208 in other embodiments.

Additionally, other peripherals coupled to the ICH 220 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like.

Hence, the computing device 202 may include volatile and/or nonvolatile memory. For example, nonvolatile memory may include one or more of the following: read-only memory (ROM), programmable ROM (PROM), erasable PROM (EPROM), electrically EPROM (EEPROM), a disk drive (e.g., 228), a floppy disk, a compact disk ROM (CD-ROM), a digital video disk (DVD), flash memory, a magneto-optical disk, or other types of nonvolatile machine-readable media suitable for storing electronic instructions and/or data.

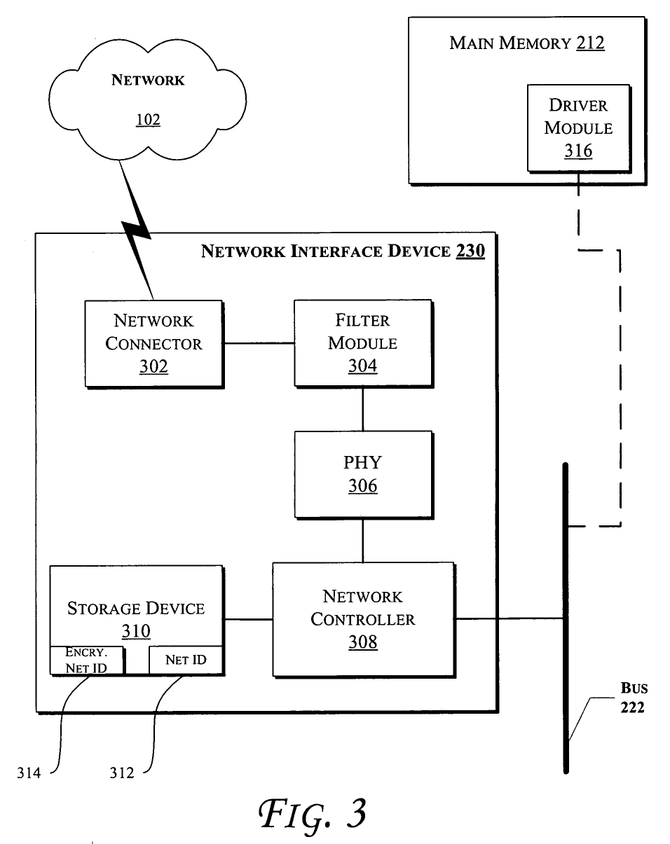

FIG. 3 illustrates further details of the network interface device 230 of FIG. 2, in accordance with an embodiment. The network interface device 230 may be coupled to the network 102 through a network connector 302. As discussed with reference to FIG. 1, network communication may be established by internal and/or external network interface devices such as a network interface card (NIC). The internal network interface device may be any suitable network interface device such as a device couple to a PCI bus (222), a device coupled to a PCI Express hub, and a device implemented on a main system board (or motherboard). Also, network communication may be through wired (e.g., access unit interface (AUI), RJ-45, and the like) and/or wireless (e.g., 802.11) connections. Accordingly the network connector 302 may be any suitable network connector that complies with various network types, such as those discussed with reference to FIG. 1.

The network connector 302 is coupled to a filter module 304 to filter communication signals transmitted or received from the network 102, e.g., to perform address filtering. The filter module 304 is coupled to a physical layer (PHY) interface 304 which performs data translation at the physical layer, such that the data communicated between the network 102 and a network controller 308 is formatted in accordance with various implementations of the network 102 (such as those discussed with reference to FIG. 1). The network controller 308 may be a general-purpose processor such as the CPU 202 of FIG. 2. The network controller 308 is coupled to the bus 222 (as discussed with reference to FIG. 2) to communicate data between the network 102 and the computing device 202.

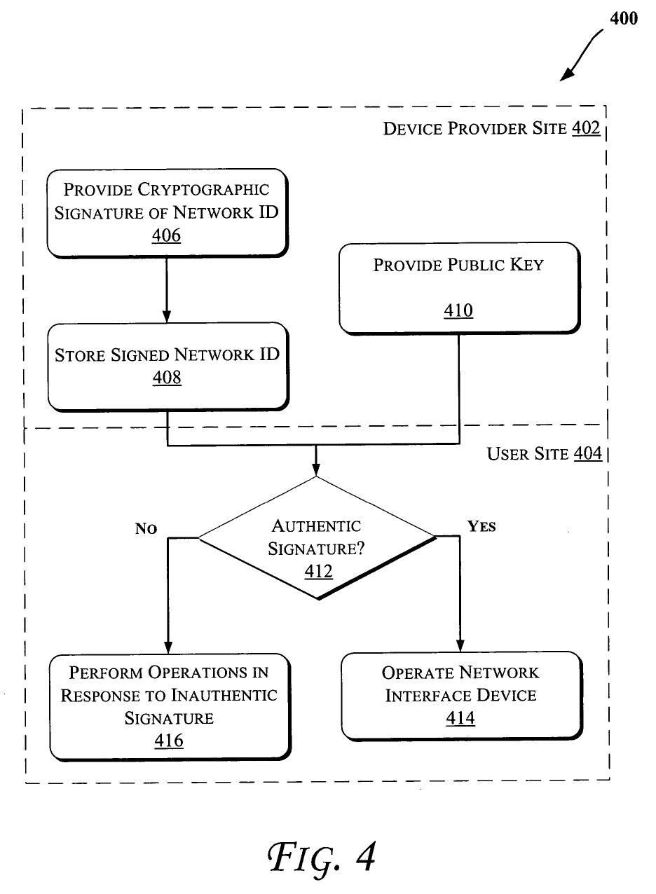

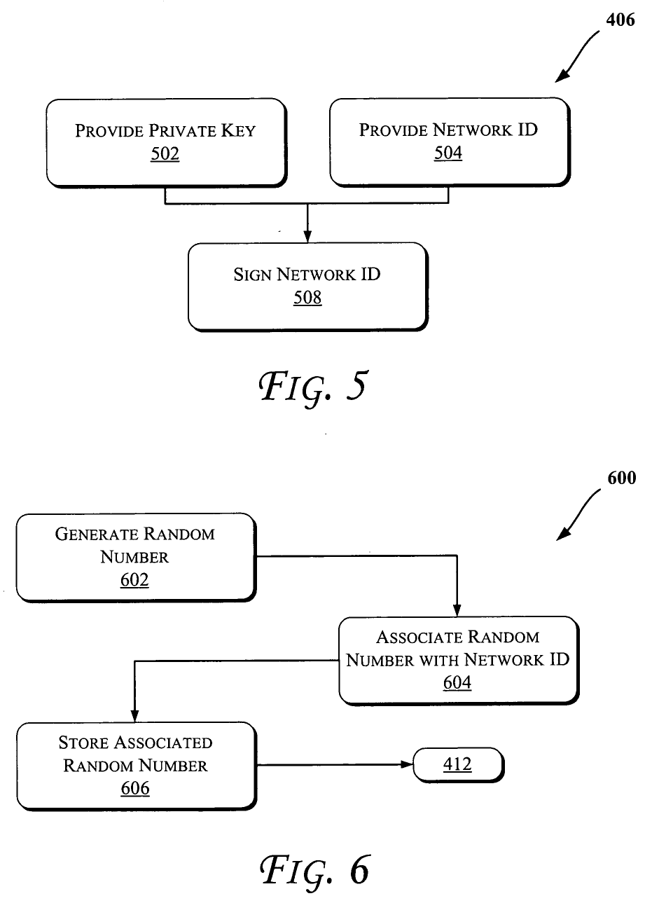

As illustrated in FIG. 3, the network controller 308 is also coupled to a storage device 310. The storage device 310 may be any suitable nonvolatile storage device such as those discussed with reference to FIG. 2 (e.g., flash memory, ROM device, EEPROM, and the like). The storage device 310 may store data regarding the network interface device 230, such as a network identifier (312) and/or other configuration information including fixed (e.g., PCI) configuration parameters. The network identifier may be a unique network identifier such a media access control (MAC) address. For example, the network identifier may be globally unique to enable identification of the respective network interface device (230) on any suitable computer network (e.g., 102). Additionally, the storage device 310 may store a cryptographically signed version of the network identifier 312 (314) as is discussed herein, e.g., with reference to FIGS. 4-5.

As illustrated in FIG. 3, a driver module 316 may communicate with the network controller 308 through the bus 222. The driver module 316 may be stored in any suitable memory such as the illustrated main memory 212 (see, e.g., FIG. 2). The driver module 316 may be stored in the disk drive 228, and optionally transferred to the main memory 212 for execution by the CPU 202. The driver module 316 may be implemented as logic and/or a software module that is provided as a computer program product, which may include a machine-readable or computer-readable medium having stored thereon instructions used to program a computer (or other electronic devices such as the network controller 308) to perform a process discussed herein. The machine-readable medium may include any suitable storage device such as those discussed with respect to FIG. 2.

Additionally, the driver module 316 may be downloaded as a computer program product, wherein the program may be transferred from a remote computer (e.g., a server (104 of FIG. 1)) to a requesting computer (e.g., a client (106, 108, and/or 114 of FIG. 1)) by way of data signals embodied in a carrier wave or other propagation medium via a communication link (e.g., a modem or network connection). Accordingly, herein, a carrier wave shall be regarded as comprising a machine-readable medium.

FIG. 4 illustrates a flow diagram of a method 400 for providing a cryptographically signed network identifier in accordance with an embodiment. Portions of the method 400 may be utilized by a non-expert to detect counterfeit network interface devices (230) through a public key. Also, in one embodiment, counterfeit network interface devices (230) may be detected in the field.

As illustrated in FIG. 4, select stages may be performed at a device provider's site (402). Other stages may be performed at a user site (404), e.g., in the field. A device provider site (402) provides a cryptographically signed network identifier (406). In one embodiment, the network identifier is a unique network identifier such as a MAC address. As discussed with reference to FIG. 3, the signed network identifier may be stored (408) in the storage device 310 (e.g., 314) that is coupled to the network controller 308. Hence, a manufacturer or distributor of an NIC may place a cryptographically signed network identifier in the memory of the NIC.

The signed network identifier and a public key (410) may be utilized to verify whether the signature is authentic (412). The verification (412) may be performed by the network controller 308 and/or the driver module 316 of FIG. 3. The public key may be stored in the storage device 310. If the signed network identifier is authentic (412), the network interface device (230) that corresponds to the network identifier may be operated (414). Otherwise, one or more operations may be performed in response to the inauthentic signature (416). For example, the network interface device (230) may be disabled and/or an error message may be displayed that the network interface device (230) is a counterfeit.

In one embodiment, a signal may be generated to indicate a failure in authentication (e.g., at the stage 412). The signal may be processed on a network interface device (230), e.g., by the network controller 308, or by another processor (e.g., through the driver module 316) to perform the one or more operations (416).

FIG. 5 illustrates further details regarding the stage 406 of FIG. 4, in accordance with an embodiment. As discussed with reference to FIG. 4, the stage provides a cryptographic signature of the network identifier. Cryptology generally relates to the enciphering (or encrypting) and deciphering (decrypting) of data. The encryption and decryption may use some secret information (such as a key). In one embodiment, such as that illustrated in FIG. 5, a private key (502) and the network identifier (504) are used to cryptographically sign the network identifier (508) (e.g., sign 312 of FIG. 3 with a private key to provide 314 of FIG. 3).

FIG. 6 illustrates a flow diagram of a method 600 for determining whether a private key is compromised, in accordance with an embodiment. In a stage 602, a random number is generated, such as a serial number. The generated random number is associated (604) with a network identifier such as a MAC address. The random number may be stored (606) in a nonvolatile memory device. For example, the random number and the associated network identifier may be stored in the storage device 308. Alternatively, the random number may be stored in a different location on the network interface device (230). Also, the random number and the associated network identifier may be stored with the device provider. Hence, the authentication stage 412 of FIG. 4 may determine that the private key utilized to sign the network identifier is compromised if a validly signed network identifier lacks a corresponding random number stored in a storage device.

Additionally, the network interface device (230) may be registered (e.g., over the phone or online) with information such as the network identifier (e.g., a MAC address), the signed network identifier, and/or the random number with a device provider. The registration may be performed at the time the driver (316) is being installed. This allows tracking of non-counterfeit network interface devices (230) to determine which devices may have been counterfeited.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a network controller to communicate with a network; and
a storage device coupled to the network controller to store a cryptographically signed unique network identifier.

2. The apparatus of claim 1, wherein the network identifier is a media access control address.

3. The apparatus of claim 1, wherein the network identifier corresponds to a unique network interface device.

4. The apparatus of claim 1, further comprising a driver module coupled to the network controller to verify an authenticity of the cryptographically signed network identifier in accordance with a public key.

5. The apparatus of claim 1, wherein the network controller verifies an authenticity of the cryptographically signed network identifier in accordance with a public key.

6. The apparatus of claim 1, wherein the storage device stores a public key corresponding to the cryptographically signed network identifier.

7. The apparatus of claim 1, wherein the network controller and the storage device are implemented in a network interface device.

8. The apparatus of claim 7, wherein the network interface device is selected from a group comprising an internal network interface device and an external network interface device.

9. The apparatus of claim 8, wherein the internal network interface device is selected from a group comprising a device coupled to a PCI bus, a device coupled to a PCI Express hub, and a device implemented on a motherboard.

10. The apparatus of claim 1, wherein the storage device is a nonvolatile storage device selected from a group comprising a flash memory device and a ROM device.

11. The apparatus of claim 1, wherein the storage device is an EEPROM.

12. The apparatus of claim 1, wherein the computer network is selected from a group comprising a wired network and a wireless network.

13. The apparatus of claim 1, wherein the network controller is a general-purpose processor.

14. A method comprising:
providing a network controller to communicate with a network; and
coupling the network controller to a storage device to store a cryptographically signed unique network identifier.

15. The method of claim 14, wherein the network identifier is a media access control address.

16. The method of claim 14, further comprising verifying an authenticity of the signed network identifier in accordance with a public key.

17. The method of claim 16, wherein the verifying act is performed by an item selected from a group comprising the network controller and a driver module stored on a computer-readable medium.

18. The method of claim 14, further comprising signing the network identifier with a private key.

19. The method of claim 14, further comprising disabling a network interface device corresponding to the network controller if the signed network identifier is inauthentic.

20. The method of claim 14, further comprising determining that a private key utilized to sign the network identifier is compromised if a validly signed network identifier lacks a corresponding random number stored in a storage device.

21. The method of claim 14, further comprising registering the network identifier and a corresponding random number with a network interface device provider.

22. A system comprising:
a volatile storage device coupled to a computing device to store data; and
a nonvolatile storage device coupled to a network controller to store a cryptographically signed unique network identifier.

23. The system of claim 22, further comprising a display device coupled to the computing device.

24. The system of claim 22, wherein the volatile storage device is selected from a group comprising RAM, DRAM, and SDRAM memory devices.
